(19) United States
(12) Patent Application Publication
(10) Pub. No.: US 2022/0341196 A1
(43) Pub. Date: Oct. 27, 2022

(54) NOZZLE ASSEMBLY FOR 3D PRINTER OF BUILDING CONSTRUCTION AND METHODS FOR OPERATING THE SAME

(71) Applicants: Hisys Co., Ltd., Gimpo (KR); Black Buffalo 3D Corporation, New York, NY (US)

(72) Inventor: CHULHYUN JOO, Bucheon-si (KR)

(21) Appl. No.: 17/730,115

(22) Filed: Apr. 26, 2022

Related U.S. Application Data
(60) Provisional application No. 63/180,641, filed on Apr. 27, 2021.

(51) Int. Cl. E04G 21/04

(52) U.S. Cl. CPC E04G 21/0445; E04G 21/0427; B33Y 30/00

(57) ABSTRACT

a nozzle assembly for a 3D printer of building construction includes: a chamber to contain a flowable mixture to form a constructional material layer; an outlet to discharge the flowable mixture in a first direction, the outlet being supported for movement in a second direction intersecting the first direction; and an edge smoothing device extending in the first direction from the lower end of the outlet to guide the flow of the flowable mixture discharged from the outlet and to provide a substantially flat side surfaces of the constructional material layer formed according to the movement of the outlet in the second direction.

### CROSS-REFERENCE TO RELATED APPLICATION

This application claims priority from and the benefit of U.S. Provisional Patent Application No. 63/180,641, filed on Apr. 27, 2021, which is hereby incorporated by reference for all purposes as if fully set forth herein.

### BACKGROUND

### Field

Embodiments of the invention relate generally to 3D printers for the construction industry and, more particularly, to a nozzle assembly for a 3D printer of building construction capable of smoothly finishing an uneven side surface of a constructional material layer and methods for operating the same.

### Discussion of the Background

In general, reinforced concrete structures have high compressive strength and are widely used as structures such as the walls of buildings. However, according to this conventional method of constructing a reinforced concrete structure, the formwork must be installed, and after the concrete has cured, the formwork must be dismantled one by one. Accordingly, there is a disadvantage in that the number of processes is large, and as a result, the construction time period and costs are large.

On the other hand, recently, 3D printing manufacturing technology for molding a product of a three-dimensional shape through printing has been in the spotlight, and attempts are being made to manufacture a concrete structure using 3D printing to solve the above-mentioned conventional problems. For example, the generally known 3D printing method for concrete is to improve lamination by simply using a concrete mix with a low water-cement ratio (W/C), and attempts to produce and automate an atypical concrete have been made.

Specifically, as a method of building construction using the 3D printing manufacturing technology, the contour crafting method known as stacked construction technology has been used primarily. The contour crafting method is a method in which construction materials such as cement are thinly laminated and stacked continuously.

The contour crafting method has improved the problem of convex sagging in the process of stacking the material and the problem of the lower part of the member being crushed as the load of the material increase.

The above information disclosed in this Background section is only for understanding of the background of the inventive concepts, and, therefore, it may contain information that does not constitute prior art.

### SUMMARY

Applicant recognized that the conventional 3D printer system using the contour crafting method disadvantageously produces ragged side surfaces of the multiple, stacked constructional layers (e.g., uneven surfaces).

Nozzle assemblies for 3D printer of building construction constructed according to the principles and illustrative embodiments of the invention and methods for operating the same are capable of smoothly finishing at least one side surface of a constructional material layer, e.g., by including a layer finishing unit positioned below an outlet for discharging a flowable mixture of the constructional material layer.

Additional features of the inventive concepts will be set forth in the description which follows, and in part will be apparent from the description, or may be learned by practice of the inventive concepts.

According to one aspect of the invention, a nozzle assembly for a 3D printer of building construction includes: a chamber to contain a flowable mixture to form a constructional material layer; an outlet to discharge the flowable mixture in a first direction, the outlet being supported for movement in a second direction intersecting the first direction; and an edge smoothing device extending in the first direction from the lower end of the outlet to guide the flow of the flowable mixture discharged from the outlet and to provide a substantially flat side surfaces of the constructional material layer formed according to the movement of the outlet in the second direction.

The chamber may be formed in interior of a housing, and the edge smoothing device may include a layer finishing unit.

The layer finishing unit may include: a roller having an outer surface to form substantially smoothly side surfaces of the constructional material layer, a cleaner positioned on the outer surface of the roller to remove contaminants from the outer surface of the roller, and a supporter attaching the roller and the cleaner to the housing.

The cleaner may include a cleaning unit and the supporter may include a bracket.

The roller may include a pair of rollers extending in the first direction from the outer end of the outlet and facing each other in a third direction intersecting the second direction, and the roller may be supported for rotation when the roller comes into contact with side surfaces of the flowable mixture discharged from the outlet.

The supporter may be fixed to the housing by a plurality of fasteners, and the pair of rollers may be spaced apart by a distance in the third direction that is adjustable based upon the fixing depth of the fasteners.

The cleaner may include a pair of cleaners located on the outer surface of each roller, and the cleaner extending in the first direction by a length equal to that of the roller, and the cleaner may be configured to remove contaminants generated by the roller contacting the flowable mixture.

The device may further include: a driving motor located on a side of the housing, a pulley coupled to a rotor of the driving motor, a rotation unit disposed between the housing and the outlet to rotate the layer finishing unit by a predetermined angle according to an operation of the driving motor, and a driving transmission belt connecting the pulley and the rotation unit.

The layer finishing unit may include: a single roller extending in the first direction from the outer end of the outlet and configured to provide a side surface of the constructional material layer with a substantially uniform edge, a single cleaner positioned on the outer surface of the roller to remove contaminants from the outer surface of the roller, and a supporter supporting the roller and the cleaner and attached to the rotation unit.

The supporter may be fixed to the rotation unit by a plurality of fasteners, and the roller supported by the supporter may rotate at substantially the same angle as the rotation unit based upon the rotation of the rotation unit.

According to another aspect of the invention, a method for operating a nozzle assembly for 3D printer of building construction, the method includes the steps of: discharging flowable mixture from an outlet in a first direction; moving the outlet in a second direction intersecting the first direction to form a constructional material layer; guiding the flow of the flowable mixture discharged from the outlet; and forming a substantially uniform edge at least one side surfaces of the constructional material layer formed by the movement of the outlet in the second direction.

The step of forming a substantially uniform edge may include: contacting a pair of rollers with side surfaces of the flowable mixture discharged mixture discharged from the outlet, and removing contaminants generated by the roller contacting the flowable mixture.

The rollers may face each other in a third direction intersecting the second direction and are supported by a supporter, the supporter being fixed to a housing by a plurality of fasteners, and may further include a step of adjusting a distance between the pair of rollers in the third direction based upon the fixing depth of the fasteners.

The method may further include the steps of: converting a movement direction of the outlet from the second direction to the third direction; operating a driving motor to rotate a rotation unit by a predetermined angle corresponding to the converted direction; and rotating a roller by the predetermined angle and based upon the operation of the driving motor.

The step of forming a substantially uniform edge may include: contacting the roller with a surface of the flowable mixture discharged mixture discharged from the outlet, and removing contaminants generated by the roller contacting with the flowable mixture.

The roller may be supported by a supporter, the supporter being fixed to the rotation unit by a plurality of fasteners and the rotation unit being connected to the driving motor through a driving transmission belt and a pulley.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 is a perspective view of an embodiment of a 3D printer system for building construction including a nozzle assembly constructed according to the principles of the invention.

FIG. 2A is a perspective view of a first embodiment of the nozzle assembly of FIG. 1.

FIG. 2B is a front view of the nozzle assembly of FIG. 2A.

FIG. 2C is a side view of the nozzle assembly of FIG. 2A.

FIG. 3A is a front view of a second embodiment of the nozzle assembly of FIG. 1.

FIG. 3B is a side view of the nozzle assembly of FIG. 3A.

FIGS. 4A and 4B are bottom views of a second embodiment of the nozzle assembly of FIGS. 3A and 3B.

FIGS. 5A and 5B are perspective views illustrating an operation of the second embodiment of the nozzle assembly of FIGS. 3A and 3B.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or flowable connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

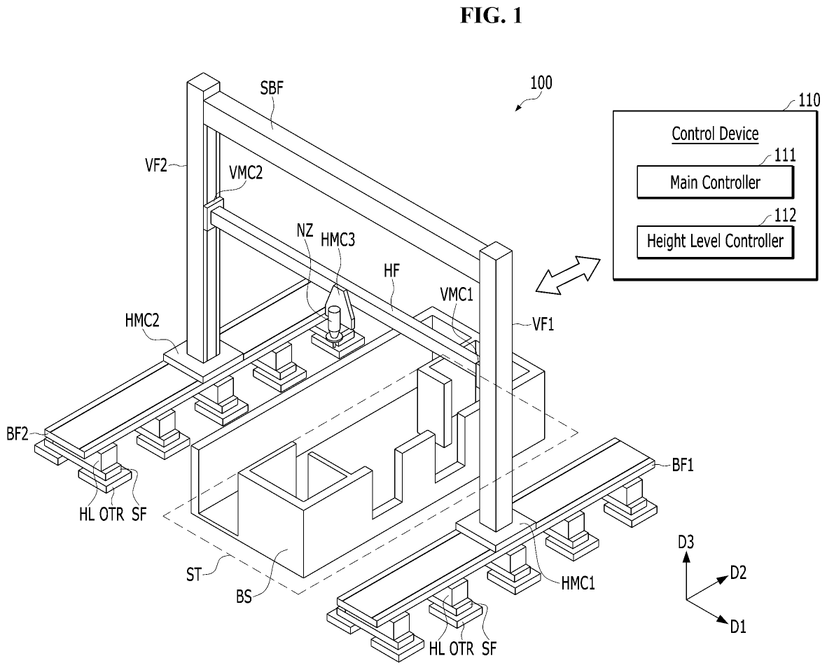

FIG. 1 is a perspective view of an embodiment of a 3D printer system for building construction including a nozzle assembly constructed according to the principles of the invention.

Referring to FIG. 1, a 3D printer system 100 especially adapted for building construction components includes outriggers OTR, support frames SF, height levelers HL, first and second base frames BF1 and BF2, first and second vertical frame shafts VF1 and VF2, first and second horizontal movement carriages HMC1 and HMC2, a horizontal frame shaft HF, first and second vertical movement carriages VMC1 and VMC2, a nozzle, which may be in the form of nozzle assembly NZ, a third horizontal movement carriage HMC3, and a control device 110.

In an embodiment, the nozzle assembly NZ may include an edge smoothing device, which may be in the layer finishing unit positioned below an outlet for discharging a flowable mixture, thereby enabling the nozzle assembly to finish smoothly at least one side surface of a constructional material layer. In other words, the layer finishing unit is configured to provide at least one side surface of the constructional material layer with a substantially uniform edge. For example, the layer finishing unit may be mounted at the lower end of the outlet to finish smoothly an uneven side surface of the constructional material layer sequentially stacked.

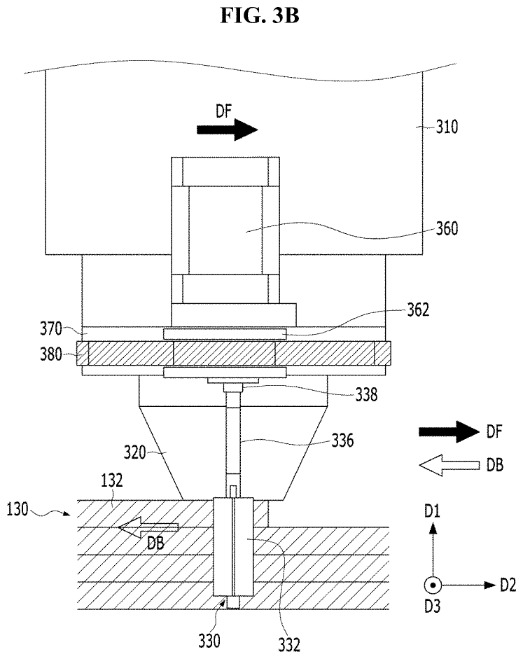

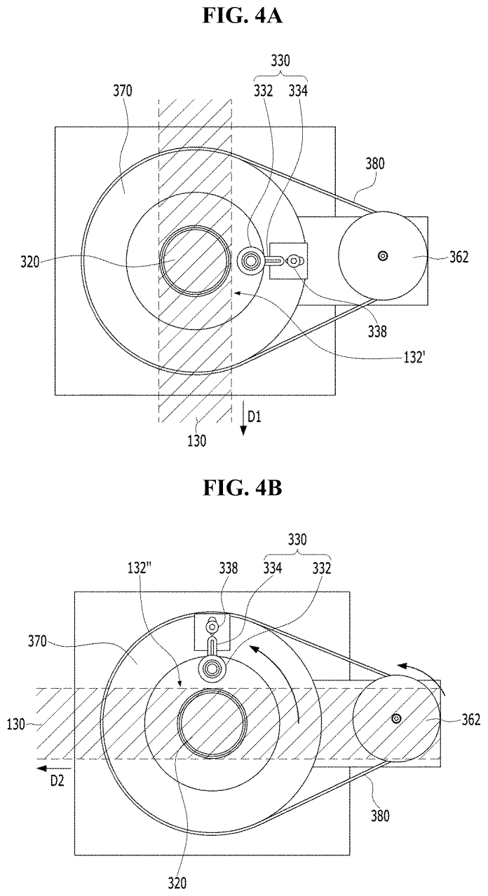

Accordingly, the nozzle assembly NZ may improve the durability of the construction by increasing the bonding force between the stacked constructional material layers. Further, the nozzle assembly NZ may prevent the discharged material from flowing down to the uneven surface between the stacked constructional material layers, as such it can also prevent the problem of the construction material layer collapsing. The nozzle assembly NZ will be described in detail with reference to FIGS. 3 through 6.

The 3D printer system 100 may further include an automatic leveling system 120 to maintain the 3D printer system 100 in a substantially horizontal orientation, as is important in building construction. For example, first and second base frames BF1 and BF2 may be horizontally oriented along a horizontal plane even if the ground surface is angled relative to the horizontal plane. The horizontal plane may be a plane substantially perpendicular to the direction of gravity and be substantially parallel with first and second axial directions D1 and D2. The horizontally oriented 3D printer system 100 may build a structure BS in a site ST as desired with a relatively low errors or tolerances since the structure BS is also required to be horizontally oriented. The automatic leveling system may include some of elements of the 3D printer system 100, such as the outriggers OTR, the support frames SF, the height levelers HL, the first and second base frames BF1 and BF2, and first and second vertical frame shafts VF1 and VF2.

A support structure for the 3D printer system 100, which may be in the form of the outriggers OTR and support frames SF, supports the first and second base frames BF1 and BF2 and the first and second vertical frame shafts VF1 and VF2 on the ground surface. The support frames SF may be provided as base members of the 3D printer system 100, which support the first and second base frames BF1 and BF2 and the first and second vertical frame shafts VF1 and VF2 horizontally. The outriggers OTR horizontally fix the support frames SF to the ground.

A height adjusting mechanism, which may be in the form of the height levelers HL, supports elements of the 3D printer system 100 disposed thereon, such as the first and to second base frames BF1 and BF2 and the first and second vertical frame shafts VF1 and VF2, at adjustable distances above the ground surface. In an embodiment, the height levelers HL may be disposed between the support frames SF and the first and second base frames BF1 and BF2 to support the first and second base frames BF1 and BF2. In this case, the height levelers HL may adjust the distances (or heights of the first and second base frames BF1 and BF2 from the ground) between the first and second base frames BF1 and BF2 and the ground. In an embodiment, the 3D printer system 100 may include the same number of the height levelers HL as the outriggers OTR.

The first and second base frames BF1 and BF2 are spaced apart from each other in the first direction and parallel with each other, and each of the first and second base frames BF1 and BF2 generally extends in the second direction D2 intersecting the first direction D1. The first and second base frames BF1 and BF2 may be disposed on the height levelers HL, and may support the first and second vertical frame shafts VF1 and VF2 linear movement in the second direction D2. In an embodiment, the first and second base frames BF1 and BF2 each may include one or more guide rails protruding from its body and extending in the second direction D2 to guide linear movement of one of the first and second vertical frame shafts VF1 and VF2.

Legs of the 3D printer system 100, which may be in the form of a pair of the first and second vertical frame shafts VF1 and VF2, are disposed on the first and second base frames BF1 and BF2. The first and second vertical frame shafts VF1 and VF2 each may extend in a third direction D3 intersecting the first and second directions D1 and D2. The first and second vertical frame shafts VF1 and VF2 are linearly movable along the first and second base frames BF1 and BF2. In an embodiment, the first horizontal movement carriage HMC1 may be disposed between the first base frame BF1 and the first vertical frame shaft VF1 to move the first vertical frame shaft VF1 along the first base frame BF1, and the second horizontal movement carriage HMC2 may be disposed between the second base frame BF1 and the second vertical frame shaft VF2 to move the second vertical frame shaft VF2 along the second base frame BF1.

The 3D printer system 100 may further include one or more sub frame shafts SBF to improve and/or complement the rigidity of the first and second vertical frame shafts VF1 and VF2. The one or more sub frame shafts SBF is shown as being horizontally disposed between the first and second vertical frame shafts VF1 and VF2.

The horizontal frame shaft HF extends in the first direction D1 and is supported by the first and second vertical frame shafts VF1 and VF2. The horizontal frame shaft HF may be engaged with the first and second vertical frame shafts VF1 and VF2 and supported for linear movement in the third direction D3. In an embodiment, the first vertical movement carriage VMC1 is disposed between the first vertical frame shaft VF1 and the horizontal frame shaft HF, and the second vertical movement carriage VMC2 is disposed between the second vertical frame shaft VF2 and the horizontal frame shaft HF. The horizontal frame shaft HF supports the nozzle assembly NZ.

The nozzle assembly NZ is disposed on the horizontal frame shaft HF for linear movement in the first direction D1. In an embodiment, the third horizontal movement carriage HMC3 is disposed between the nozzle assembly NZ and the horizontal frame shaft HF to move the nozzle assembly NZ along the horizontal frame shaft HF. The nozzle assembly NZ may be connected through a supply line to a material storage tank that stores materials corresponding to the structure BS, and may discharge the materials of the material tank in response to control signals from the control device 110.

The control device 110 controls the overall operation of the 3D printer system 100. The control device 110 may include a main controller 111 and a height level controller 112. The main controller 111 may move the nozzle assembly NZ by moving the first and second vertical frame shafts VF1 and VF2 in the second direction D2, moving the horizontal frame shaft HF in the third direction D3, and moving the nozzle assembly NZ in the first direction D1. In other words, the main controller 111 may control the first and second horizontal movement carriages HMC1 and HMC2 to move along the first and second base frames BF1 and BF2, and control the first and second vertical movement carriages VMC1 and VMC2 to move along the first and second vertical frame shafts VF1 and VF2, and control the third horizontal movement carriage HMC3 to move along the horizontal frame shaft HF. As such, the main controller 111 may move the first and second vertical frame shafts VF1 and VF2, the horizontal frame shaft HF, and the nozzle assembly NZ to change a position of the nozzle assembly NZ, and may control the nozzle assembly NZ to discharge the materials to form components of the building structure BS.

The height level controller 112 controls the height levelers HL to adjust the variable distances between the first and second base frames BF1 and BF2 and the ground to maintain the 3D printer system 100 in a substantially horizontal orientation.

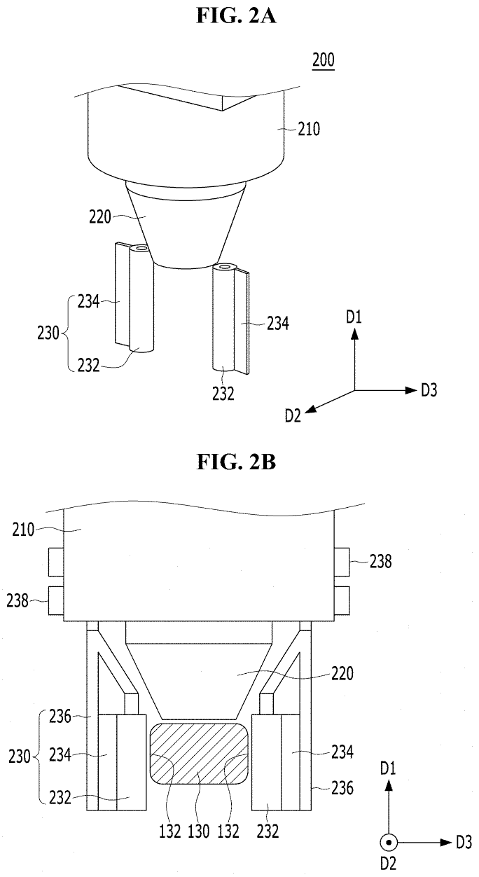

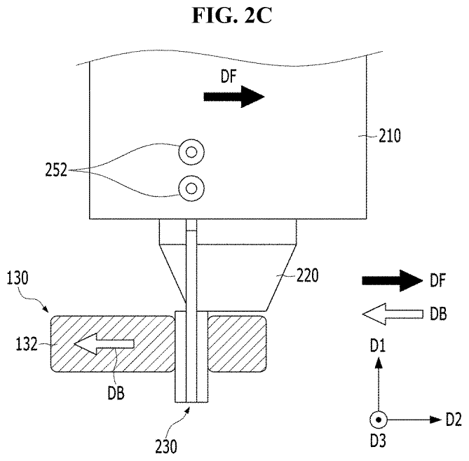

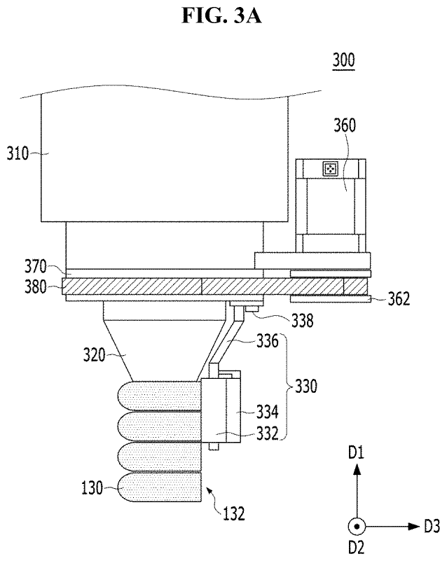

FIG. 2A is a perspective view of a first embodiment of the nozzle assembly of FIG. 1, FIG. 2B is a front view of the nozzle assembly of FIG. 2A, and FIG. 2C is a side view of the nozzle assembly of FIG. 2A.

Referring to FIG. 2A, 2B, and 2C, the nozzle assembly 200 includes a housing 210 to contain a flowable mixture to form a constructional material layer; an outlet 220 to discharge the flowable mixture in a first direction D1 (e.g., a height direction or Z-axis direction), the outlet 200 being supported for movement in a second direction D2 (e.g., a longitudinal direction or Y-axis direction) intersecting the first direction D1; and an edge smoothing device, which may be in a layer finishing unit 230 extending in the first direction D1 from the lower end of the outlet 220 to guide the flow of the flowable mixture discharged from the outlet 220 and to finish smoothly side surfaces of the constructional material layer formed according to the movement of the outlet in the second direction D2.

The housing 210 may receive the flowable mixture of a constructional material layer. For example, the mixture may a mixture of mortar and water (e.g., a fluid concrete). The mortar may be a material in which cement, sand, fiber, and admixture are mixed, and concrete agitation is performed by mixing the mortar with water, and the flowable mixture may be introduced into the housing 210 of the nozzle assembly 200.

The introduced flowable mixture may be discharged through the outlet 220, and the discharged flowable mixture may form a predetermined constructional material layer 130 according to the moving direction (e.g., D2 direction of FIGS. 2A, 2B, and 2C) of the nozzle assembly 200 (NZ in FIG. 1).

More specifically, referring to FIG. 2C, the outlet 220 of the nozzle assembly 200 is supported by the housing 210 for linear movement in a second direction D2 intersecting the first direction D1. For example, the outlet 220 may move in a forward direction DF of the second direction D2. Accordingly, when the outlet 220 moves in the forward direction DF of the second direction D2, the flowable mixture discharged from the outlet 220 forms constructional material layer 130 in the backward direction DB of the second direction D2.

The 3D printer may form a predetermined constructional structure while the constructional material layers are stacked. In the conventional case, the conventional 3D printer using the contour crafting method may have a problem in that side surfaces of the multiple constructional layers stacked become ragged (e.g., uneven surfaces).

To solve this problem, the nozzle assembly 200 may further include the layer finishing unit 230, as such the nozzle assembly 200 is able to guide the flow of the flowable mixture discharged from the outlet 220 and to finish smoothly side surfaces of the constructional material layer formed according to the linear movement of the outlet in the second direction D2. In other words, the layer finishing unit 230 is configured to provide at least one side surface of the constructional material layer with a substantially uniform edge.

The layer finishing unit 230 may include a roller 232 to finish smoothly side surfaces of the constructional material layer 130, a cleaner, which may be in the form of a cleaning unit 234 positioned on the outer surface of the roller 232 to remove contaminants from the outer surface of the roller 232, and a supporter, which may be in the form of a bracket 236 supporting the roller and the cleaning unit and attached to the housing 210.

Referring to FIGS. 2A, 2B, and 2C, the roller 232 may include a pair of rollers 232 extending in the first direction D1 from the outer end of the outlet 210 and facing each other in a third direction D3 (e.g., a width direction or X-axis direction). The roller 232 rotates when the roller 232 comes into contact with the side of the flowable mixture discharged from the outlet 220. At this time, when the nozzle assembly 200 moves in the second direction D2 and the roller 232 rotates, the side surface 132 of the constructional material layer 130 formed while in contact with the roller 232 has a smooth shape (an even surface).

Accordingly, the pair of rollers 232 are configured to guide the flow of the flowable mixture discharged from the outlet 220, and finish smoothly the side surface 132 of the constructional material layer 130 formed as the outlet 220 moves in the second direction D2.

The cleaning unit 234 may include a pair of cleaning units 234 located on the outer surface of each roller 232. The cleaning unit 234 may extend in the first direction D1 and has substantially the same length as the roller 232, and may remove contaminants generated by the roller contacting with the flowable mixture. For example, the cleaning unit 232 may have a scraper shape as shown FIG. 2B.

Referring to FIG. 2B, the roller 232 and the cleaning unit 234 are supported by the supporter 236, and the supporter 236 is attached to the housing 210. For example, the supporter 236 may be fixed to the housing 210 by a plurality of fasteners 238. In an embodiment, when fixing the supporter 236 to the housing 210, the distance between the pair of rollers 232 in the third direction D3 may be adjusted according to the fixing depth of the fasteners 238. The distance between the rollers 232 may be the width of the constructional material layer 130. That is, the layer finishing unit 230 may adjust the width of the constructional material layer 130.

However, the nozzle assembly 200 shown in FIGS. 2A to 2C is limited in that the nozzle assembly 200 is able to operate the side finishing operation of the constructional material layer 130 only when the outlet 220 moves in one single direction. That is, when the movement direction of the outlet 220 is changed, the nozzle assembly 200 is not able to operate the side finishing operation of the constructional material layer 130. For example, as shown in FIG. 2C, when the outlet 220 moves in the second direction D2 (Y-axis direction), the side finishing operation of the constructional material layer 130 is possible, but when the direction is changed from the second direction D2 to the third direction D3 (X-axis direction), the side finishing operation of the constructional material layer 130 is not possible.

To solve this problem, the nozzle assembly 300 according to another embodiment further includes a driving motor 360, a pulley 362, a driving transmission belt 380, and a rotation unit 370, so that a side surface of the constructional material layer 130 can be finished smoothly even though the movement direction of the outlet 320 is changed according to the movement path of the outlet 320. Hereinafter, a nozzle assembly 300 according to another embodiment will be described in more detail with reference to FIGS. 3A to 5B.

FIG. 3A is a front view of a second embodiment of the nozzle assembly of FIG. 1, and FIG. 3B is a side view of the nozzle assembly of FIG. 3A.

Referring to FIGS. 3A and 3B, the nozzle assembly 300 constructed according to the second embodiment, like the nozzle assembly 200 shown in FIGS. 2A, 2B, and 2C, includes a housing 310 to contain a flowable mixture to form a constructional material layer; an outlet 320 to discharge the flowable mixture in a first direction D1, the outlet 320 being supported for linear movement in a second direction D2 intersecting the first direction D1; and a layer finishing unit 330 extending in the first direction D1 from the lower end of the outlet 320 to guide the flow of the flowable mixture discharged from the outlet 320 and to finish smoothly side surfaces of the constructional material layer formed according to the linear movement of the outlet in the second direction D2.

In addition, the nozzle assembly 300 further includes a driving motor 360 located on a side of the housing 310, a pulley 362 coupled to a rotor of the driving motor 360, a rotation unit 370 disposed between the housing 310 and the outlet 320 to rotate the layer finishing unit 330 by a predetermined angle according to an operation of the driving motor 360, and a driving transmission belt 380 connecting the pulley 362 and the rotation unit 370.

As described above, the housing 310 may receive the flowable mixture of a constructional material layer. For example, the mixture may a mixture of mortar and water (e.g., a fluid concrete).

The introduced flowable mixture may be discharged through the outlet 320, and the discharged flowable mixture may form a predetermined constructional material layer 130 according to the moving direction (e.g., D2 direction of FIGS. 3A and 3B) of the nozzle assembly 300 (NZ in FIG. 1). FIGS. 3A and 3B show a structure in which a plurality of constructional material layers 130 are stacked.

More specifically, referring to FIG. 3B, the outlet 320 of the nozzle assembly 300 is supported by the housing 310 for movement in a second direction D2 intersecting the first direction D1. For example, the outlet 320 may move in a forward direction DF of the second direction D2. Accordingly, when the outlet 320 moves in the forward direction DF of the second direction D2, the flowable mixture discharged from the outlet 320 forms constructional material layer 130 in the backward direction DB of the second direction D2.

The layer finishing unit 330 may include a roller 332 to finish a side surface of the constructional material layer 130, a cleaning unit 334 positioned on the outer surface of the roller 332 to remove contaminants from the outer surface of the roller 332, and supporter 336 supporting the roller 332 and the cleaning unit 334 and attached to the housing 310.

Referring to FIGS. 3A and 3B, the roller 332 may include a single roller 332 extending in the first direction D1 from the outer end of the outlet 310. In an embodiment, even if the movement direction of the outlet 320 is changed, single roller 332 may be provided to perform the side finishing operation of the constructional material layer 130.

The roller 332 rotates when the roller 332 comes into contact with the side of the flowable mixture discharged from the outlet 320. At this time, when the nozzle assembly 300 moves in the second direction D2 and the roller 332 rotates, the side surface 132 of the constructional material layer 130 formed while in contact with the roller 332 has a smooth shape (a substantially even surface).

Accordingly, the roller 332 is configured to finish smoothly the side surface 132 of the constructional material layer 130 formed as the outlet 320 moves. In other words, the roller 332 is configured to provide the side surface 132 of the constructional material layer 130 with a substantially uniform edge.

The cleaning unit 334 may be located on the outer surface of the roller 332. The cleaning unit 334 may extend in the first direction D1 and have substantially the same length as the roller 332, and may remove contaminants generated by the roller contacting with the flowable mixture. For example, the cleaning unit 332 may have a scraper shape as shown FIG. 3A.

Referring to FIG. 3B, the roller 332 and the cleaning unit 334 are supported by the supporter 336, and the supporter 336 is attached to the rotation unit 370. For example, the supporter 336 may be fixed to the rotation unit 370 by a plurality of fasteners 338. Therefore, when the rotation unit 370 rotates, the roller 332 fixed to the supporter 336 also rotates at the same angle as the rotation unit 370. That is, since the rotation unit 370 is connected to the driving motor 360 through the driving transmission belt 380 and the pulley 362, the rotation unit 370 may be able to rotate the layer finishing unit 330 by a predetermined angle according to an operation of the driving motor 360.

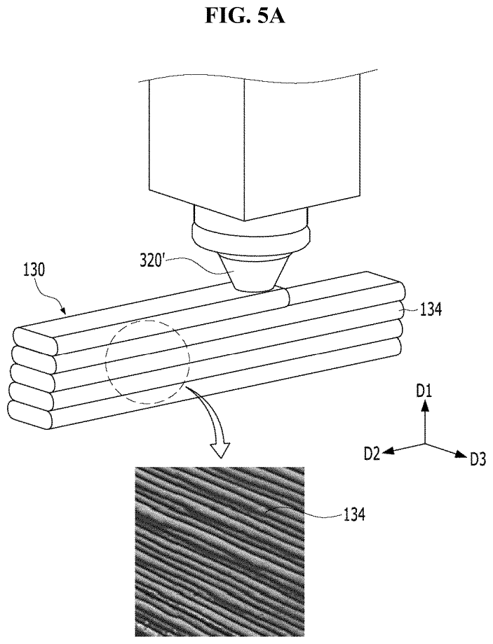

An operation of the nozzle assembly 330 according to the second embodiment will be described in more detail with reference to FIGS. 4A and 4B.

FIGS. 4A and 4B are bottom views of the second embodiment of the nozzle assembly 300 of FIGS. 3A and 3B.

Specifically, FIG. 4A illustrates an operation in which the outlet 320 moves in the first direction D1 (e.g., Y-axis direction) and the constructional material layer 130 is also formed in the first direction D1, and FIG. 4B illustrates an operation when the movement direction of the outlet 320 is converted to a second direction D2 (e.g., X-axis direction) and the constructional material layer 130 is also formed in the second direction D2.

First, referring first to FIG. 4A, the roller 332 included in the layer finishing unit 330 rotates when the roller 332 comes into contact with the side surface of the flowable mixture discharged from the outlet 320. At this time, when the outlet 320 moves in the first direction D1 and the roller 332 rotates, the side surface (e.g., the right side surface of FIG. 4A) 132′ of the constructional material layer 130 formed while contacting with the roller 332 may have a smooth shape (a substantially even surface). That is, the side surface 132′ of the constructional material layer 130 may have a substantially uniform edge.

Next, referring to FIG. 4B, when the outlet 320 that has been moving in the first direction D1 shown in FIG. 4A changes movement direction to a second direction D2 intersecting with the first direction D1 (e.g., intersecting at 90 degrees), the driving motor 360 operates, and the rotating unit is rotated from the first direction D1 to the second direction D2 through the pulley 362 and the driving transmission belt 380 connected to the driving motor 360.

For example, as shown in FIG. 4B, when the pulley 362 connected to the driving motor 360 rotates 90 degrees counterclockwise, the rotation unit 370 also rotates 90 degrees counterclockwise accordingly. As a result, the layer finishing unit 330 including the roller 332 and the cleaning unit 334 also rotates 90 degrees counterclockwise.

Next, when the outlet 320 moves in the second direction D2 and the roller 332 rotates, the side surface (e.g., the upper side surface of FIG. 4B) 132″ of the constructional material layer 130 formed while contacting with the roller 332 may have a smooth shape (a substantially even surface). That is, the side surface 132″ of the constructional material layer 130 may have a substantially uniform edge.

The main controller 111 of the control device 110 shown in FIG. 1 may control conversion of the movement direction of the nozzle assembly 300 and operate the driving motor 360.

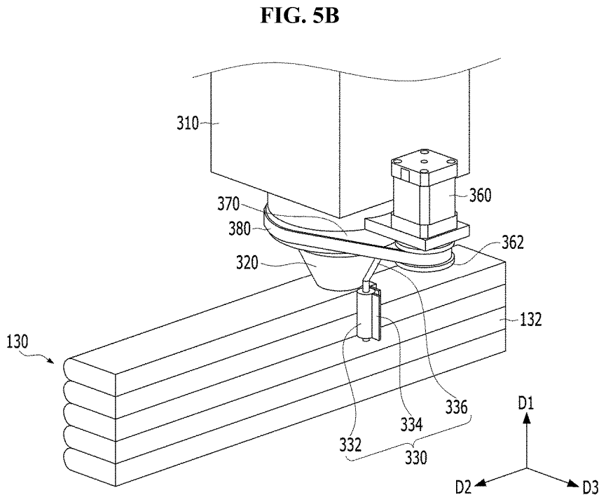

FIGS. 5A and 5B are perspective views illustrating an operation of the second embodiment of the nozzle assembly of FIGS. 3A and 3B.

First, FIG. 5A is a comparative example, which describes the operation of the nozzle assembly according to the conventional art. Referring to FIG. 5A, since the layer finishing unit is not provided at the lower end of the outlet 320′, the side surfaces 134 of the multiple constructional layers 130 formed by the movement of the outlet 320′ stacked become ragged (e.g., uneven surfaces) as shown in the expanded portion of FIG. 5A.

In contrast, FIG. 5B illustrates the operation of the nozzle assembly 300 according to the second embodiment shown in FIGS. 3A and 3B. The same reference numerals are used for the same components as those of FIGS. 3A and 3B, and repetitive descriptions will be omitted to avoid redundancy.

Referring to FIG. 5B, in the illustrated embodiment above, since the layer finishing unit 330 including the roller 332, the cleaning unit 334, and the supporter 336 is provided at the lower end of the outlet 320, when the outlet 320 moves in the second direction D2 and the roller 332 rotates, the side surface (e.g., the right side surface of FIG. 5B) 132 of the constructional material layers 130 formed while contacting with the roller 332 may have a substantially smooth shape (a substantially even surface). That is, the side surface 132 of the constructional material layer 130 may have a substantially uniform edge.

Although certain illustrative embodiments and implementations have been described herein, other embodiments and modifications will be apparent from this description.

Accordingly, the inventive concepts are not limited to such embodiments, but rather to the broader scope of the appended claims and various obvious modifications and equivalent arrangements as would be apparent to a person of ordinary skill in the art.

What is claimed is:

1. A nozzle assembly for a 3D printer of building construction, the nozzle assembly comprising:
a chamber to contain a flowable mixture to form a constructional material layer;
an outlet to discharge the flowable mixture in a first direction, the outlet being supported for movement in a second direction intersecting the first direction; and
an edge smoothing device extending in the first direction from the lower end of the outlet to guide the flow of the flowable mixture discharged from the outlet and to provide a substantially flat side surfaces of the constructional material layer formed according to the movement of the outlet in the second direction.

2. The device of claim 1, wherein the chamber is formed in interior of a housing and the edge smoothing device comprises a layer finishing unit.

3. The device of claim 2, wherein the layer finishing unit comprises:
a roller having an outer surface to form substantially smoothly side surfaces of the constructional material layer,
a cleaner positioned on the outer surface of the roller to remove contaminants from the outer surface of the roller, and
a supporter attaching the roller and the cleaner to the housing.

4. The device of claim 3, wherein the cleaner comprises a cleaning unit and the supporter comprises a bracket.

5. The device of claim 3, wherein the roller comprises a pair of rollers extending in the first direction from the outer end of the outlet and facing each other in a third direction intersecting the second direction, and
wherein the roller is supported for rotation when the roller comes into contact with side surfaces of the flowable mixture discharged from the outlet.

6. The device of claim 5, wherein the supporter is fixed to the housing by a plurality of fasteners, and
wherein the pair of rollers are spaced apart by a distance in the third direction that is adjustable based upon the fixing depth of the fasteners.

7. The device of claim 5, wherein the cleaner includes a pair of cleaners located on the outer surface of each roller, and the cleaner extends in the first direction by a length equal to that of the roller, and
wherein the cleaner is configured to remove contaminants generated by the roller contacting the flowable mixture.

8. The device of claim 2, further comprising:
a driving motor located on a side of the housing,
a pulley coupled to a rotor of the driving motor,
a rotation unit disposed between the housing and the outlet to rotate the layer finishing unit by a predetermined angle according to an operation of the driving motor, and
a driving transmission belt connecting the pulley and the rotation unit.

9. The device of claim 8, wherein the layer finishing unit comprises:
a single roller extending in the first direction from the outer end of the outlet and configured to provide a side surface of the constructional material layer with a substantially uniform edge,
a single cleaner positioned on the outer surface of the roller to remove contaminants from the outer surface of the roller, and
a supporter supporting the roller and the cleaner and attached to the rotation unit.

10. The device of claim 9, wherein the supporter is fixed to the rotation unit by a plurality of fasteners, and
wherein the roller supported by the supporter rotates at substantially the same angle as the rotation unit based upon the rotation of the rotation unit.

11. A method for operating a nozzle assembly for 3D printer of building construction, the method comprising the steps of:
discharging flowable mixture from an outlet in a first direction;
moving the outlet in a second direction intersecting the first direction to form a constructional material layer;
guiding the flow of the flowable mixture discharged from the outlet; and
forming a substantially uniform edge at least one side surface of the constructional material layer formed by the movement of the outlet in the second direction.

12. The method of claim 11, the step of forming a substantially uniform edge comprises:
contacting a pair of rollers with side surfaces of the flowable mixture discharged mixture discharged from the outlet, and
removing contaminants generated by the roller contacting the flowable mixture.

13. The method of claim 12, wherein the rollers face each other in a third direction intersecting the second direction and are supported by a supporter, the supporter being fixed to a housing by a plurality of fasteners, and
further comprising adjusting a distance between the pair of rollers in the third direction based upon the fixing depth of the fasteners.

14. The method of claim 11, further comprising the steps of:
converting a movement direction of the outlet from the second direction to the third direction;
operating a driving motor to rotate a rotation unit by a predetermined angle corresponding to the converted direction; and
rotating a roller by the predetermined angle based on the operation of the driving motor.

15. The method of claim 14, the step of forming a substantially uniform edge comprises:
contacting the roller with a surface of the flowable mixture discharged mixture discharged from the outlet, and
removing contaminants generated by the roller contacting with the flowable mixture.

16. The method of claim 15, wherein the roller is supported by a supporter, the supporter being fixed to the rotation unit by a plurality of fasteners and the rotation unit being connected to the driving motor through a driving transmission belt and a pulley.
